(19) United States
(12) Patent Application Publication
(10) Pub. No.: US 2024/0303377 A1
(43) Pub. Date: Sep. 12, 2024

(54) SYSTEM AND METHOD FOR PROVIDING EXCLUSIVE ACCESS TO SECONDARY STORAGE TO APPLICATION ON ANDROID DEVICE

(71) Applicant: ARRIS ENTERPRISES LLC, Suwanee, GA (US)

(72) Inventors: Sundaramoorthy BALASUBRAMANIAN, Bangalore (IN); Surya P. MAHESWARAM, Bengaluru (IN)

(21) Appl. No.: 18/266,623

(22) PCT Filed: Nov. 18, 2021
(86) PCT No.: PCT/US2021/059832

§ 371 Date: Jun. 12, 2023

Related U.S. Application Data
(60) Provisional application No. 63/125,533, filed on Dec. 15, 2020.

(51) Int. Cl. G06F 21/62

(52) U.S. Cl. CPC G06F 21/629; G06F 21/6218

(57) ABSTRACT

A method, an Android device, and a non-transitory computer readable medium for providing exclusive access to Android storage. The method includes: creating, on an Android device, an application domain for a desired application; creating, on the Android device, a Security-Enhanced Linux (SELinux) label for Media Storage on the Android device; and giving, on the Android device, permission only to the desired application to access external storage on the Android device with the SELinux label.

### TECHNICAL FIELD

The present disclosure generally relates to a system and method for providing exclusive access to secondary storage to an application on an Android device.

### BACKGROUND

Cable service providers, which are also referred to as Multiple System Operators (“MSO”), or any communication or content distribution business that operates through a cable network, renders its services to its subscribers. The services can include, but are not limited to, different subscription plans for broadband Internet access and telephony. In order to consume these services, subscribers connect to a private network owned (or co-owned or rented) by the broadband cable operator which is implemented according to the Data Over Cable Service Interface Specification (DOCSIS) standard. Subscribers connect their computers, routers, voice-over-IP telephones and other devices to this network through the network terminals, for example, cable modems (CM) or network gateways.

To provide television and data services, a MSO typically uses a Cable Modem Termination System (“CMTS”) for the data services and a quadrature amplitude modulation (“QAM”) multiplexer for downstream broadcast television, narrow cast and video-on-demand (VOD) traffic signals. These devices may be located at one or more hubs, which are typically connected to a head end via a network according to a networking protocol, such as Ethernet or SONET. A residential cable customer is typically connected to the CMTS and hub via a cable modem and a wireless router that may be combined in a single box which is called a gateway. In order to view, for example, video content that is transmitted through the cable modem or gateway, residential customers connect, for example, their televisions to a set-top box (STB).

The set-top box can be used by the subscriber to access a variety of multimedia services, including but not limited to live or linear television, digital video recorder (DVR) content, video-on-demand (VOD) content, over-the-top (OTT) content, and others. For example, set-top boxes usually play user selected content, for example, either live or with a digital video recorder (DVR). In addition, content can be accessed by remote controllers and/or via a voice or speech detection application system.

For devices having the Android operating system (OS), only system applications or applications signed with platform keys can access media storage. In addition, if one wants to give access to Media Storage exclusively, for example, to a television application (“tvapp”), it is not possible. There is also a chance of other system applications viewing the stored content of other applications, for example, stored in Media Storage.

SELinux (Security-Enhanced Linux) is a Linux kernel security module that provides a mechanism for supporting access control security policies, for example, including mandatory access controls. For example, files, network ports, and other hardware can have a SELinux context, consisting of a name, role, and type. In the case of file system, mapping between files and the security context is called labeling.

It would be desirable to have a system and method for providing exclusive access to secondary storage to an application, for example, a television application (tvapp) on a device with an Android operating system (e.g., an Android device), and which can enhance the user's experience, for example, by providing an extended “pause buffer” using, for example, a SELinux label.

### SUMMARY

In accordance with an aspect, a method is disclosed for providing exclusive access to Android storage, the method comprising: creating, on an Android device, an application domain for a desired application; creating, on the Android device, a Security-Enhanced Linux (SELinux) label for Media Storage on the Android device; and giving, on the Android device, permission only to the desired application to access external storage on the Android device with the SELinux label.

In accordance with an another aspect, an Android device is disclosed, the Android device comprising: an Android operating system; a processor; and a memory storing instructions that, when executed by the processor, causes the Android device to: create an application domain for a desired application; create a Security-Enhanced Linux (SELinux) label for Media Storage; and give permission only to the desired application to access secondary storage with the SELinux label.

In accordance with a further aspect, a non-transitory computer readable medium is disclosed having instructions operable to cause one or more processors to perform operations comprising: creating, on an Android device, an application domain for a desired application; creating, on the Android device, a Security-Enhanced Linux (SELinux) label for Media Storage on the Android device; and giving, on the Android device, permission only to the desired application to access external storage on the Android device with the SELinux label.

### BRIEF DESCRIPTION OF THE DRAWINGS

FIG. 1 is an illustration of an exemplary network environment for a system and method for providing exclusive access to secondary storage to a desired application on an Android device in accordance with an exemplary embodiment.

FIG. 2 is an illustration of an existing solution of Media Storage for an Android device.

FIG. 3 is an illustration of a system for providing exclusive access to secondary storage to a desired application on an Android device in accordance with an exemplary embodiment.

FIG. 4 is a flowchart illustrating a method for providing exclusive access to secondary storage to a desired application on an Android device in accordance with an exemplary embodiment.

FIG. 5 is an exemplary hardware architecture for an embodiment of a communication device in accordance with an exemplary embodiment.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

### System for Providing Exclusive Access to Secondary Storage

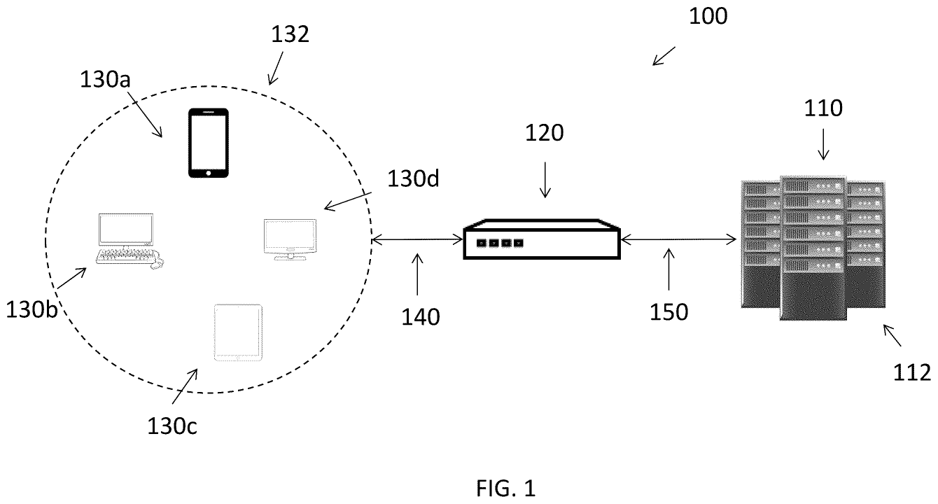

FIG. 1 depicts a block diagram of a high-level system architecture for providing exclusive access to secondary storage to a desired application on an Android device. The architecture may be embodied in a system 100, which includes one or more servers 110, for example, of a cable service provider 112, a customer-premise equipment or customer-provided equipment (CPE) 120, and a plurality of devices or clients 130a, 130b, 130c, 130d. The customer-premise equipment or customer-provided equipment (CPE) 120 can be, for example, a smart media device (SMD).

In accordance with an exemplary embodiment, the customer-premise equipment or customer-provided equipment (CPE) 120, and/or one or more of the plurality of devices or clients 130a, 130b, 130c, 130d can include an Android operating system (e.g. an Android device) and can include, for example, an internal television application (tvapp).

In embodiments, the CPE 120 can provide, for example, video and/or data services to the plurality of devices or clients 130a, 130b, 130c, 130d. The CPE 120 may communicate with the plurality of devices 130a, 130b, 130c, 130d over a local network 132 (for example, a local area network (LAN), a wireless local area network (WLAN), a personal area network (PAN), etc.) and/or wired, connected to a modem, and may communicate with an upstream wide area network (WAN) through a connection 150 to the one or more servers 110, for example, of the cable service provider 112. The one or more servers 110 can provide high-bandwidth data transfer, for example, cable television and broadband Internet access via, for example, the connection 150. The one or more servers 110 of the cable service provider 112 can be configured to deliver services, for example, cable television and/or broadband Internet.

In accordance with an exemplary embodiment, the CPE 120 and the plurality of devices 130a, 130b, 130c, 130d can be configured to connect via a wireless network, for example, wireless network utilizing an IEEE 802.11 specification, including a set-top box (STB), a smart phone, a smart TV, a computer, a mobile device, a tablet, a router, a home security system, or any other device operable to communicate wirelessly with the CPE 120. The CPE 120 may provide access to an external network, such as the Internet, for any devices connected thereto via the area network 132. The area network 132 may be, for instance a local area. In accordance with an exemplary embodiment, the CPE broadband device 120 may be a smart media device, a gateway device, an access point, a modem, a wireless router including an embedded modem, a wireless network extender or any other device operable to deliver, for example, data and/or video services from the one or more servers 110 of the cable service provider 112 and/or a wide area network (WAN) to one or more of the plurality of devices 130a, 130b, 130c, 130d.

In accordance with an exemplary embodiment, the CPE 120 may communicate with the one or more servers 110 over a wired or a wireless connection. A wireless connection between the one or more servers 110 of the cable service provider 112 and the CPE broadband device 120 may be established through a protected setup sequence (for example, Wi-Fi protected setup (WPS)). The protected setup sequence may include the steps of scanning multiple wireless channels for an available access point, exchanging one or more messages between a station and access point, exchanging key messages (for example, pre-shared key (PSK)) between the station and access point, and installing a key (for example, PSK) at the station.

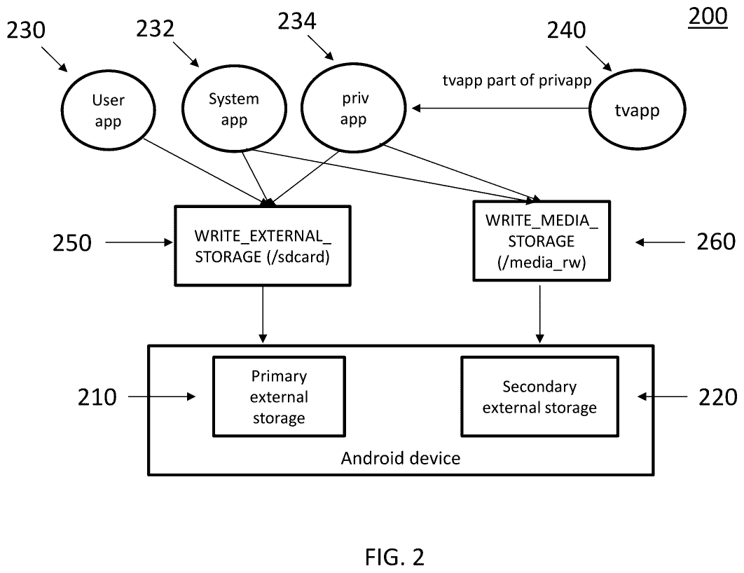

As shown in FIG. 2, Android devices 200 generally have two types of external storage, a primary external storage 210 and a second external storage 220. The primary external storage 210 can be, for example, emulated in flash (typically, for example, “/data/media”). Each user generally must have their own isolated primary external storage and do not have access to the primary external storage of the other users. The “/sdcard” path must resolve to the correct user-specific primary external storage based on the user a process is running as, for example, Permission Required: WRITE_EXTERNAL_STORAGE 250.

The secondary external storage 220 can be a physical (portable) secure digital (SD) card. The SD card can be configured as adoptable storage or Media Storage. For example, if the user configures the sdcard 220 as adoptable storage then any application (e.g., system application (System app) 232 and privilege application (priv app) 234) can store the corresponding application's files into the sdcard 220. For example, if the sdcard 220 is configured as media storage then the application requires permission: WRITE_MEDIA_STORAGE 260.

If one wants to give access of media storage exclusively, for example, a television application (“tvapp”) 240 it is not possible. In addition, there is chance of other system applications 230, 232, 234 viewing the stored content of other applications, for example, stored in the Media Storage.

### System for Providing Exclusive Access to Secondary Storage

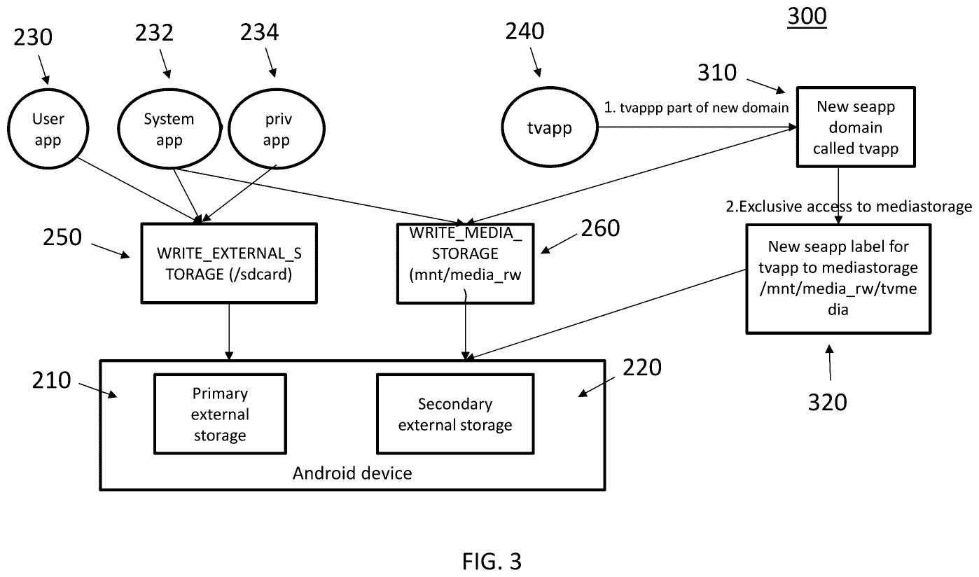

FIG. 3 is an illustration of a system 300 for providing exclusive access to secondary storage to a desired application on an Android device in accordance with an exemplary embodiment. As shown in FIG. 3, for example, to give access permission to only specific applications or desired applications, for example, a television application (tvapp) 240, a new application domain and group (e.g., application domain) 310 is created for the television application 240. In accordance with an exemplary embodiment, the application domain can be a mechanism used with the Common Language Infrastructure (CLI) to isolate executed software application from one another so that they do not affect each other. For example, each application can have its own virtual address space, which scopes the resources for the application domain using that address space.

In addition, a new SELinux (Security-Enhanced Linux) label 320 can be created, which gives the new application domain 310 for example, for the television application 240 (e.g., desired application), exclusive access to the Media Storage (e.g., /mnt/media_rw/tvmedia). The SELinux labeling can be defined, for example, in policy files, but can also be manually adjusted without changing the policies. The policy rules for SELinux consists of explicit permissions, for example, which domains the user must possess to perform certain actions with the given target (read, execute, or, in case of network port, bind or connect). For example, with SELinux, more complex mappings can also be defined using roles and security levels.

### Method for Providing Exclusive Access to Secondary Storage

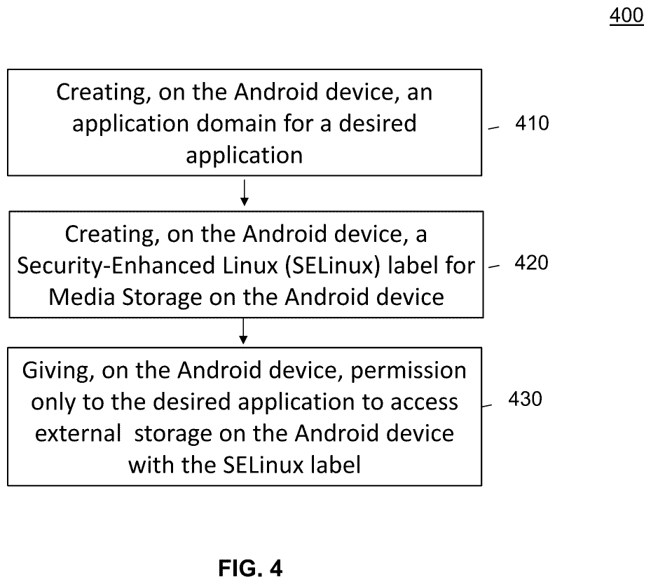

FIG. 4 is a flowchart 400 illustrating a method for providing exclusive access to secondary storage to a desired application on an Android device 120, 130a, 130b, 130c, 130d, 300 in accordance with an exemplary embodiment. As shown in FIG. 4, in step 410, an application domain for a desired application is created on the Android device. In step 420, a Security-Enhanced Linux (SELinux) label for Media Storage on the Android device is created. In step 430, permission is given only to the desired application to access external storage on the Android device with the SELinux label.

In accordance with an exemplary embodiment, the external storage on the Android device includes a primary external storage and a secondary external storage, and the application is given permission to access the secondary external storage on the Android device. In accordance with an exemplary embodiment, the secondary external storage is a secure digital (SD) card. The desired application can be, for example, an internal television application on the Android device. In accordance with an exemplary embodiment, the television application is configured to deliver linear television or multicast television to one or more client devices. The Android device can be a customer-premise equipment (CPE), for example, a set-top box, or a smart phone or tablet.

### Computer System Architecture

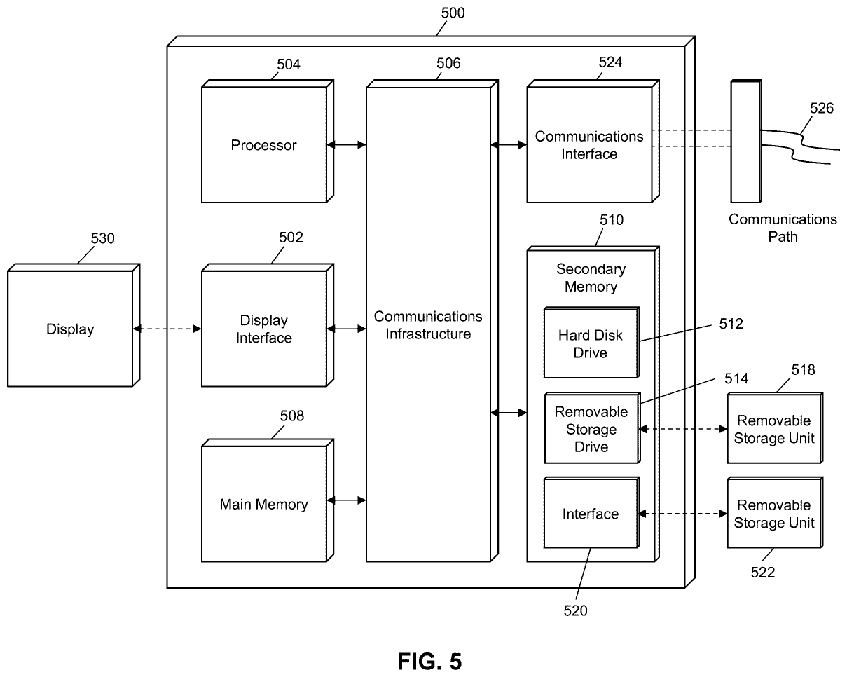

FIG. 5 illustrates a representative computer system 500 in which embodiments of the present disclosure, or portions thereof, may be implemented as computer-readable code executed on a processor of a computer. For example, the one or more servers 110, the CPE 120, and the plurality of devices 130a, 130b, 130c, 130d, of FIG. 1 may be implemented in whole or in part by a computer system 500 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the present disclosure.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this representative computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 1-4, as discussed herein. Accordingly, such computer programs may represent controllers of the computer system 500. Where the present disclosure is implemented using software executed on hardware, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software executed on hardware, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for providing exclusive access to secondary storage to an application on an Android device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing exclusive access to Android storage, the method comprising:
creating, on an Android device, an application domain for a desired application;
creating, on the Android device, a Security-Enhanced Linux (SELinux) label for Media Storage on the Android device; and
giving, on the Android device, permission only to the desired application to access external storage on the Android device with the SELinux label.

2. The method according to claim 1, wherein the external storage on the Android device includes a primary external storage and a secondary external storage, the method comprising:
giving the desired application permission to access the secondary external storage on the Android device.

3. The method according to claim 2, wherein the secondary external storage is a secure digital (SD) card.

4. The method according to claim 1, wherein the desired application is an internal television application on the Android device.

5. The method according to claim 1, wherein the Android device is a customer-premise equipment (CPE).

6. The method according to claim 1, wherein the Android device is a smart phone or tablet.

7. An Android device, the Android device comprising:
an Android operating system;
a processor; and
a memory storing instructions that, when executed by the processor, causes the Android device to:
create an application domain for a desired application;
create a Security-Enhanced Linux (SELinux) label for Media Storage; and
give permission only to the desired application to access secondary storage with the SELinux label.

8. The Android device according to claim 7, wherein the external storage on the Android device includes a primary external storage and a secondary external storage, the processor configured to:
give the application permission to access the secondary external storage on the Android device.

9. The Android device according to claim 8, wherein the secondary external storage is a secure digital (SD) card.

10. The Android device according to claim 7, wherein the desired application is an internal television application on the Android device.

11. The Android device according to claim 7, wherein the Android device is a customer-premise equipment (CPE).

12. The Android device according to claim 7, wherein the Android device is a smart phone or tablet.

13. A non-transitory computer readable medium having instructions operable to cause one or more processors to perform operations comprising:
creating, on an Android device, an application domain for a desired application;
creating, on the Android device, a Security-Enhanced Linux (SELinux) label for Media Storage on the Android device; and
giving, on the Android device, permission only to the desired application to access external storage on the Android device with the SELinux label.

14. The non-transitory computer readable medium according to claim 13, wherein the external storage on the Android device includes a primary external storage and a secondary external storage, the operations further comprising:
giving the desired application permission to access the secondary external storage on the Android device.

15. The non-transitory computer readable medium according to claim 14, wherein the secondary external storage is a secure digital (SD) card.

16. The non-transitory computer readable medium according to claim 13, wherein the desired application is an internal television application on the Android device.

17. The non-transitory computer readable medium according to claim 13, wherein the Android device is a customer-premise equipment (CPE).

18. The non-transitory computer readable medium according to claim 13, wherein the Android device is a smart phone or tablet.
